(19) United States
(12) Patent Application Publication
(10) Pub. No.: US 2026/0125239 A1
(43) Pub. Date: May 7, 2026

(54) WIRE BODY WINDING MECHANISM AND DATA CABLE DEVICE

(71) Applicant: Anker Innovations Technology Co., Ltd., Changsha (CN)

(72) Inventors: Xianjie Tang, Shenzhen (CN); Songya Chen, Shenzhen (CN); Tao Chen, Shenzhen (CN)

(21) Appl. No.: 19/438,826

(22) Filed: Jan. 2, 2026

Related U.S. Application Data
(63) Continuation of application No. PCT/CN2024/103138, filed on Jul. 2, 2024.

(30) Foreign Application Priority Data
Jul. 3, 2023 (CN) 202321722615.6

(51) Int. Cl. B65H 75/44; B65H 75/48; H02G 11/02

(52) U.S. Cl. CPC B65H 75/4428; B65H 75/486; H02G 11/02; B65H 2701/34

(57) ABSTRACT

Disclosed are a wire winding system and a data cable device. The wire winding system comprises a base, a winding assembly, a locking assembly, and a reset member. A first bearing surface of the base comprises one of a ring-shaped guide groove and a rolling groove. The winding assembly comprises a rotary shaft and a bracket. The locking assembly comprises a swing member and a rolling member. A surface of the swing member facing the first bearing surface comprises the other of the ring-shaped guide groove and the rolling groove. The ring-shaped guide groove comprises a locking point recess. The rolling member is embedded in the rolling groove and the ring-shaped guide groove.

### CROSS-REFERENCE TO RELATED APPLICATIONS

The present disclosure claims priority to PCT/CN2024/103138, filed on Jul. 2, 2024, which claims priority to Chinese Patent Application No. 202321722615.6 filed on Jul. 3, 2023 and entitled “Wire Body Winding Mechanism and Data Cable Device”, each of which is incorporated herein by reference in its entirety.

### FIELD

The present disclosure relates to the technical field of conductive connection devices, in particular to a wire body winding mechanism and a data cable device.

### BACKGROUND

A data cable device on the market includes a base, a bracket, a rolling member, and a data cable. The bracket is rotatably connected to the base, and the data cable is wound around the bracket about a rotation axis of the bracket. The bracket has a ring-shaped guide groove on a side thereof facing the base, and the base has a rolling groove on a side thereof facing the bracket. The rolling member rolls in the ring-shaped guide groove and the rolling groove. During a process in which the data cable extends or retracts, the rolling member is in direct contact with the bracket, causing wear on the bracket when the rolling member rolls in the rolling groove and the ring-shaped guide groove. Therefore, reducing the potential for bracket wear caused by the rolling member's movement within the rolling groove and the ring-shaped guide groove has become an issue.

### SUMMARY

Examples of the present disclosure provide a wire body winding mechanism (e.g., wire winding system) and a data cable device, which can solve the problem of wear on the bracket when the rolling member rolls in the rolling groove and the ring-shaped guide groove in the related art.

According to a first aspect, an example of the present disclosure provides a wire winding system. The wire winding system comprises a base, a winding assembly, a locking assembly, and a reset member. The base comprises a first bearing surface, and the first bearing surface comprises a mounting hole and one of a ring-shaped guide groove and a rolling groove that extends along a radial direction of the mounting hole. The winding assembly is configured to automatically wind a wire. The winding assembly comprises a rotary shaft and a bracket. The rotary shaft can pass through the mounting hole and is rotatably connected to the base. The bracket may be located on a side of the base where the first bearing surface is, and may be fixedly connected to the rotary shaft. The wire can rest against a side of the bracket facing away from the first bearing surface. The locking assembly may be located between the first bearing surface and the bracket, and may comprise a swing member and a rolling member. The swing member may be rotatably connected to the base, and a surface of the swing member facing the first bearing surface comprises the other of the ring-shaped guide groove and the rolling groove. The ring-shaped guide groove comprises a locking point recess. The rolling member may be embedded in the rolling groove and the ring-shaped guide groove. The reset member is connected to the base. Extension or retraction of the wire may drive the rotary shaft and the bracket to rotate synchronously, so that the bracket engages with or disengages from the swing member, thereby driving the swing member to swing. The rolling member may be driven by the swing member to roll along the rolling groove and the ring-shaped guide groove. When the rolling member rolls to the locking point recess, the bracket is held in a state of engaging with the swing member, so that a position of the rotary shaft is fixed relative to the base. When the bracket disengages from the swing member, the reset member may cause the swing member to have a motion tendency to rotate to engage with the bracket.

Based on the wire body winding mechanism according to an example of the present disclosure, by providing the swing member and providing one of the rolling groove and the ring-shaped guide groove on the surface of the swing member facing the first bearing surface, the direct contact between the rolling member and the bracket can be effectively avoided as compared with a case of providing the ring-shaped guide groove directly on a surface of the bracket facing the first bearing surface, thereby effectively reducing the possibility of wear on the bracket when the rolling member rolls in the rolling groove and the ring-shaped guide groove.

According to a second aspect, an example of the present disclosure provides a data cable device. The data cable device comprises a wire body and the wire body winding mechanism. The wire body comprises a data cable, and the data cable is wound around the rotary shaft about the axis of the rotary shaft.

Based on the data cable device according to an example of the present disclosure, the data cable device including the above wire body winding mechanism can effectively prevent the rolling member from directly contacting the bracket during the process of extension or retraction of the data cable, thereby effectively reducing the possibility of wear on the bracket when the rolling member rolls in the rolling groove and the ring-shaped guide groove.

### BRIEF DESCRIPTION OF THE DRAWINGS

In order to more clearly illustrate technical solutions in examples of the present disclosure or in the related art, drawings that need to be used in description of the examples or the related art are briefly introduced below. Apparently, the drawings in the following description are merely some examples of the disclosure, and other drawings can be obtained in accordance with these drawings without inventive work for those of ordinary skill in the art.

FIG. 1 is a structural diagram of a wire body winding mechanism/data cable device according to an example of the present disclosure;

FIG. 2 is a structural diagram of the wire body winding mechanism/data cable device from another viewing angle according to an example of the present disclosure;

FIG. 3 is an exploded structural diagram of a wire body winding mechanism/data cable device according to an example of the present disclosure;

FIG. 4 is a structural diagram of a swing member and a base that are rotatably connected according to an example of the present disclosure;

FIG. 5 is a structural diagram of a bracket and a rotary shaft that are connected according to an example of the present disclosure;

FIG. 6 is a structural diagram according to an example of the present disclosure, in which a ring-shaped guide groove is provided in a swing body, an engaging part is an engaging protrusion and a mating part is an engaging recess;

FIG. 7 is a structural diagram according to an example of the present disclosure, in which a ring-shaped guide groove is provided in a swing body, an engaging part is an engaging recess and a mating part is an engaging protrusion;

FIG. 8 is a structural diagram according to an example of the present disclosure, in which a rolling groove is provided in a swing body, an engaging part is an engaging protrusion and a mating part is an engaging recess;

FIG. 9 is a structural diagram according to an example of the present disclosure, in which a rolling groove is provided in a swing body, an engaging part is an engaging recess and a mating part is an engaging protrusion;

FIG. 10 is a planar structure diagram of the ring-shaped guide groove according to an example of the present disclosure;

FIG. 11A to FIG. 11C are structural diagrams showing a change process of a rolling trajectory of a rolling member in the ring-shaped guide groove during a process of pulling out a wire body according to an example of the present disclosure;

FIG. 12 is a structural diagram of positioning of the wire body after being pulled out and the rolling trajectory of the rolling member in the ring-shaped guide groove according to an example of the present disclosure;

FIG. 13A to FIG. 13D are structural diagrams showing a change process of a rolling trajectory of the rolling member in the ring-shaped guide groove during a process of winding the wire body according to an example of the present disclosure;

FIG. 14 is a structural diagram of positioning of the wire body after being wound and the rolling trajectory of the rolling member in the ring-shaped guide groove according to an example of the present disclosure;

FIG. 15 is a structural diagram of an input circuit board and an output circuit board according to an example of the present disclosure; and

FIG. 16 is an exploded structure diagram of the input circuit board and the output circuit board according to an example of the present disclosure.

### DETAILED DESCRIPTION

In order to make the object, technical solutions and advantages of the present disclosure clearer and more understandable, the present disclosure will be described in further detail below with reference to the accompanying drawings. It should be understood that the specific examples described herein are only used to explain the disclosure and but not used to limit the disclosure.

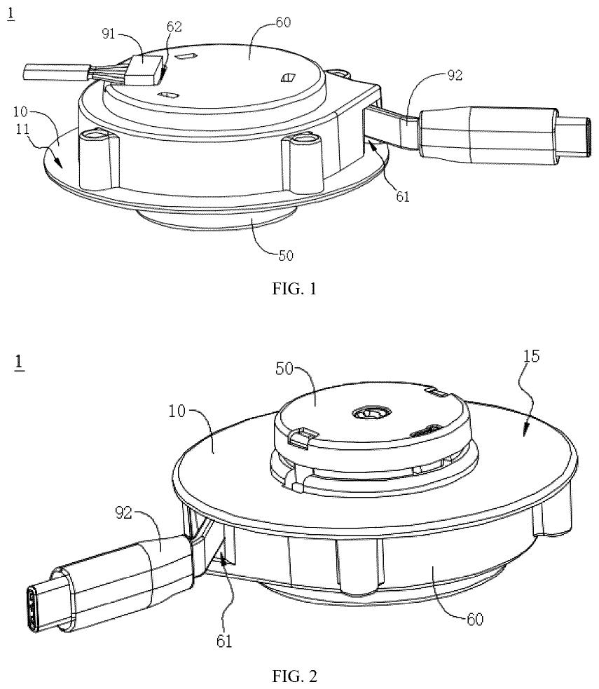

Referring to FIGS. 1 to 3, a first aspect of the present disclosure describes a wire body winding mechanism that can effectively reduce the possibility of wear on a bracket 22 caused by a rolling member 32 when the rolling member 32 rolls in a rolling groove 13 and a ring-shaped guide groove 14.

The wire body winding mechanism includes a base 10, a winding assembly 20, a locking assembly 30, and a reset member 40. The base 10 has a first bearing surface 11, which is provided with a mounting hole 12 and one of the ring-shaped guide groove 14 and the rolling groove 13, with the rolling groove 13 extending along a radial direction of the mounting hole 12. The winding assembly 20 is configured to automatically wind a wire body 92. The winding assembly 20 includes a rotary shaft 21 and the bracket 22. The rotary shaft 21 passes through the mounting hole 12 and is rotatably connected to the base 10. The bracket 22 is located on a side of the base 10 where the first bearing surface 11 is, and is fixedly connected to the rotary shaft 21. The wire body 92 rests against a side of the bracket 22 facing away from the first bearing surface 11. The locking assembly 30 is located between the first bearing surface 11 and the bracket 22, and includes a swing member 31 and the rolling member 32. The swing member 31 is rotatably connected to the base 10, and a surface of the swing member 31 facing the first bearing surface 11 is provided with one of the ring-shaped guide groove 14 and the rolling groove 13. The ring-shaped guide groove 14 includes a locking point recess 141. The rolling member 32 is embedded in the rolling groove 13 and the ring-shaped guide groove 14. The reset member 40 is connected to the base 10. When extending or retracting, the wire body 92 drives the rotary shaft 21 and the bracket 22 to rotate synchronously, so that the bracket 22 engages with or disengages from the swing member 31, thereby driving the swing member 31 to swing. The rolling member 32 is driven by the swing member 31 to roll along the rolling groove 13 and the ring-shaped guide groove 14. When the rolling member 32 rolls to the locking point recess 141, the bracket 22 is held in a state of engaging with the swing member 31, so that the position of the rotary shaft 21 is fixed relative to the base 10. When the bracket 22 disengages from the swing member 31, the reset member 40 causes the swing member 31 to have a motion tendency to rotate to engage with the bracket 22.

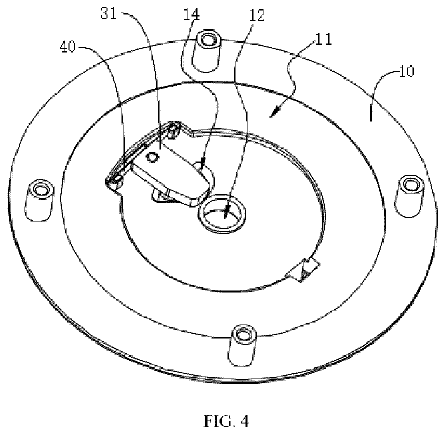

Hereinafter, a specific structure of the wire body winding mechanism is described in detail with reference to FIGS. 1 to 16.

As illustrated in FIGS. 1 to 5, the wire body winding mechanism can be used for, but is not limited to, winding of linear components such as data cables, yarns, electric cables, and flexible tubes. The wire body winding mechanism includes the base 10, the winding assembly 20, the locking assembly 30, and the reset member 40.

The base 10 serves as a carrier for bearing other components in the wire body winding mechanism. The specific shape of the base 10 is not limited here, and the designer can make a reasonable design according to actual needs. The specific preparation material of the base 10 is not limited here, and the designer can make a reasonable selection according to actual needs.

The base 10 has the first bearing surface 11, which can be a flat surface, a curved surface, or a combination of the flat surface and the curved surface. The first bearing surface 11 is provided with the mounting hole 12. The mounting hole 12 can be formed in the first bearing surface 11 of the base 10 by injection molding, 3D printing, cutting, or grinding. The mounting hole 12 can be a through hole 62 that runs through the base 10 or a blind hole that does not run through the base 10. The first bearing surface 11 is also provided with one of the ring-shaped guide groove 14 and the rolling groove 13. The ring-shaped guide groove 14 includes the locking point recess 141. A specific structure of the ring-shaped guide groove 14 will be described in detail below. The rolling groove 13 extends along the radial direction of the mounting hole 12.

As illustrated in FIGS. 1 to 5, the winding assembly 20 is a structural component in the wire body winding mechanism that is configured to wind the wire body 92. The winding assembly 20 includes the rotary shaft 21 and the bracket 22. The rotary shaft 21 penetrates the mounting hole 12 and is rotatably connected to the base 10. For example, the rotary shaft 21 can be connected to the base 10 via a bearing. The bracket 22 is configured to rest the wire body 92, and a side of the bracket 22 facing away from the first bearing surface 11 is configured to bear the wire body 92. A specific structure of the bracket 22 will be described in detail below. The bracket 22 is located on the side of the base 10 where the first bearing surface 11 is. The bracket 22 is fixedly connected to the rotary shaft 21. The bracket 22 and the rotary shaft 21 may be directly connected or indirectly connected. In the case of direct connection, the bracket 22 can form an integral structure with the rotary shaft 21 by injection molding or 3D printing. In the case of indirect connection, the bracket 22 can be fixed to the rotary shaft 21 by glue.

The winding assembly 20 can be configured to automatically wind the wire body 92. For example, the winding assembly 20 may also include an elastic member (to be described below), which is fixedly connected to the rotary shaft 21. An elastic restoring force of the elastic member drives the rotary shaft 21 to rotate, thereby achieving automatic winding of the wire body 92. Alternatively, the winding assembly 20 may also include a gear structure, which is connected to the rotary shaft 21. Components in the gear structure operate to drive the rotary shaft 21 to rotate, thereby achieving the automatic winding of the wire body 92. A specific form of the gear structure will not be described here, and the designer can adopt some gear structures in the related art that can achieve the automatic rotation of the rotary shaft 21.

As illustrated in FIGS. 1 to 5, the locking assembly 30 comprises one or more structural components configured to fix a relative position between the bracket 22 and the base 10. In other words, the relative position between the bracket 22 and the base 10 is fixed through the locking assembly 30. The locking assembly 30 is located between the first bearing surface 11 of the base 10 and the bracket 22.

For example, the locking assembly 30 includes the swing member 31 (e.g., a swing plate) and the rolling member 32. The swing member 31 is rotatably connected to the base 10. For example, the swing member 31 may be connected to the base 10 via a bearing, or the swing member 31 may be connected to the base 10 via another rotary shaft 21. A surface of the swing member 31 facing the first bearing surface 11 of the base 10 is provided with the other of the ring-shaped guide groove 14 and the rolling groove 13. The rolling member 32 is configured to relatively fix positions of the swing member 31 and the bracket 22 relative to the base 10. The rolling member 32 may be, but is not limited to, a steel ball, a rolling element, a glass ball, a roller, or other structural components that can achieve rolling. The rolling member 32 is embedded between the ring-shaped guide groove 14 and the rolling groove 13 (e.g., the rolling member 32 is sandwiched between the ring-shaped guide groove 14 and the rolling groove 13).

As illustrated in FIGS. 1 to 5, the reset member 40 is a structural component in the wire body winding mechanism that is configured to achieve automatic reset of the swing member 31. A specific form of the reset member 40 will be described in detail below. The reset member 40 is connected to the base 10. It is understandable that a relative position relationship between the reset member 40 and the base 10 and a specific connection form between the reset member 40 and the base 10 vary with different forms of the reset member 40, which will be described in detail below.

When extending or retracting, the wire body 92 can drive the rotary shaft 21 and the bracket 22 to rotate synchronously, so that the bracket 22 engages with or disengages from the swing member 31, thereby driving the swing member 31 to move (e.g., swing). The rolling member 32 is driven by the swing member 31 to roll along the rolling groove 13 and the ring-shaped guide groove 14. When the rolling member 32 rolls to the locking point recess 141, the bracket 22 is held in the state of engaging with the swing member 31, so that the rotary shaft is positioned on the base 10. When the bracket 22 disengages from the swing member 31, the reset member 40 causes the swing member 31 to have a motion tendency to rotate to engage with the bracket 22.

It should be noted that the wire body 92 may be fixedly connected to the rotary shaft 21 or the bracket 22. Because the rotary shaft 21 is fixedly connected to the bracket 22, regardless of whether the wire body 92 is fixedly connected to the rotary shaft 21 or the bracket 22, the wire body 92 can drive the rotary shaft 21 and the bracket 22 to rotate synchronously when extending or retracting. The rotation of the bracket 22 can drive the swing member 31 to swing, thereby achieving the engagement or disengagement between the bracket 22 and the swing member 31. The swing of the swing member 31 can drive the rolling member 32 to roll along the rolling groove 13 and the ring-shaped guide groove 14. When the rolling member 32 rolls to the locking point recess 141, relative action between an outer surface of the rolling member 32 and a groove wall surface of the ring-shaped guide groove 14 as well as a groove wall surface of the rolling groove 13 allows the rolling member 32 to be positioned in the locking point recess 141. The positioning of the rolling member 32 in the locking point recess 141 enables fixation of the relative position between the swing member 31 and the base 10. When the rolling member 32 rolls to the locking point recess 141, because the swing member 31 and the bracket 22 are in a relatively static engaging state, the rolling member 32 can achieve fixation of the relative position between the swing member 31 and the base 10 at the same time as fixation of the relative position between the bracket 22 and the base 10, thereby achieving fixation of the relative position between the rotary shaft 21 and the base 10.

Based on the wire body winding mechanism according to an example of the present disclosure, by providing the swing member 31 and providing one of the rolling groove 13 and the ring-shaped guide groove 14 on the surface of the swing member 31 facing the first bearing surface 11, the direct contact between the rolling member 32 and the bracket 22 can be effectively avoided as compared with a case of providing the ring-shaped guide groove 14 directly on a surface of the bracket 22 facing the first bearing surface 11, thereby effectively reduce the possibility of wear on the bracket 22 when the rolling member 32 rolls in the rolling groove 13 and the ring-shaped guide groove 14.

Further, as illustrated in FIGS. 5 to 9, in some examples, the bracket 22 includes a bracket body 221 and a mating part 222. The bracket body 221 may be fixedly connected to the rotary shaft 21, and the mating part 222 may be provided on a side of the bracket body 221 facing the first bearing surface 11. The swing member 31 includes a swing body 311 (e.g., a first plate) and an engaging part 312 (e.g., a second plate). The swing body 311 is rotatably connected to the base 10. The engaging part 312 is provided on a side of the swing body 311 facing an axis of the rotary shaft 21. The ring-shaped guide groove 14 is provided on a surface of the swing body 311 facing the first bearing surface 11. Alternatively, at least part of the rolling groove 13 is provided on the surface of the swing body 311 facing the first bearing surface 11.

When the rolling member 32 rolls to the locking point recess 141, the mating part 222 engages with the engaging part 312. In this design, by providing the engaging part 312 and the mating part 222, when the rolling member 32 rolls to the locking point recess 141, the rolling member 32 is positioned in the locking point recess 141, thereby achieving fixation of the relative position between the swing member 31 and the base 10. The engagement between the mating part 222 and the engaging part 312 brings the swing member 31 and the bracket 22 into a relatively static engaging state. Therefore, the rolling member 32 enables fixation of the relative position between the swing member 31 and the base 10 at the same time as fixation of the relative position between the bracket 22 and the base 10, thereby achieving fixation of the relative position between the rotary shaft 21 and the base 10.

The specific locations of the ring-shaped guide groove 14 and the rolling groove 13, and the specific forms of the mating part 222 and the engaging part 312 may include the following examples.

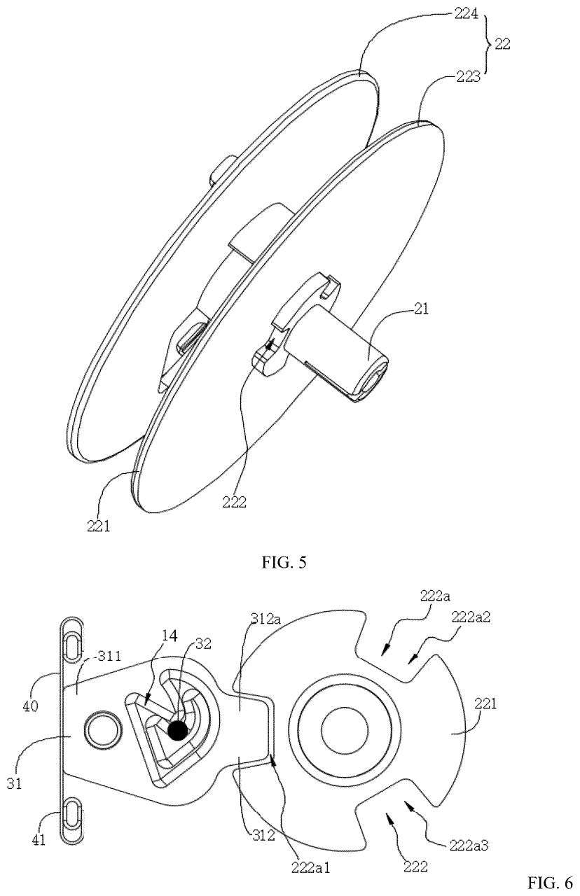

As illustrated in FIG. 6, in a first example, the ring-shaped guide groove 14 is provided on the surface of the swing body 311 facing the first bearing surface 11, and the rolling groove 13 is provided on the first bearing surface 11 of the base 10. The mating part 222 is an engaging recess 222a that is formed in an outer surface of a body of the bracket 22 (e.g., the bracket body 221) and whose opening faces away from the axis of the rotary shaft 21. The engaging part 312 includes an engaging protrusion 312a which is fixedly connected to the surface of the swing body 311 facing the axis of the rotary shaft 21. When the rolling member 32 rolls to the locking point recess 141, the engaging protrusion 312a engages with the engaging recess 222a. In this design, by providing the engaging protrusion 312a and the engaging recess 222, when the rolling member 32 rolls to the locking point recess 141, the rolling member 32 is positioned in the locking point recess 141, thereby achieving fixation of the relative position between the swing member 31 and the base 10. The engagement between the engaging protrusion 312a and the engaging recess 222a brings the swing member 31 and the bracket 22 into a relatively static engaging state. Therefore, the rolling member 32 enables fixation of the relative position between the swing member 31 and the base 10 and fixation of the relative position between the bracket 22 and the base 10, thereby achieving fixation of the relative position between the rotary shaft 21 and the base 10.

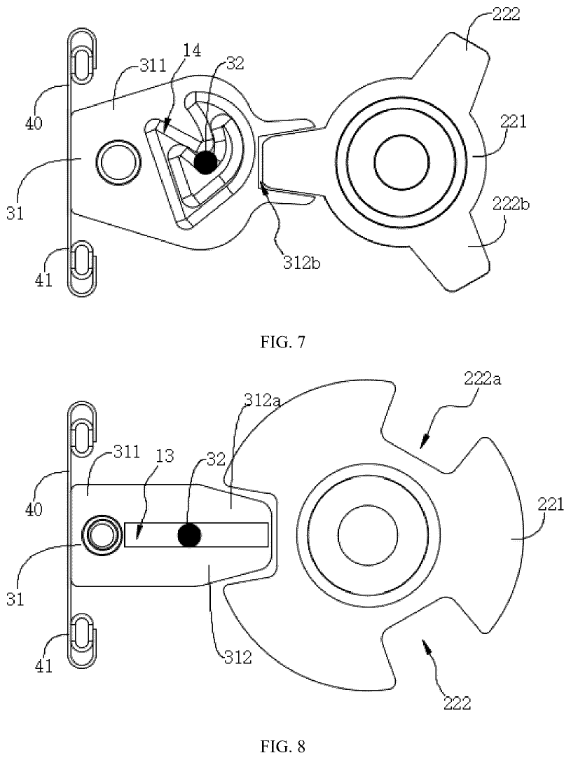

As illustrated in FIG. 7, in a second example, the ring-shaped guide groove 14 is provided on the surface of the swing body 311 facing the first bearing surface 11, and the rolling groove 13 is provided on the first bearing surface 11 of the base 10. The mating part 222 includes an engaging protrusion 222b which is fixedly connected to the surface of the bracket body 221 facing the first bearing surface 11. The engaging part 312 is an engaging recess 312b that is formed in a surface of the swing body 311 facing the axis of the rotary shaft 21 and whose opening faces the axis of the rotary shaft 21. When the rolling member 32 rolls to the locking point recess 141, the engaging recess 312b engages with the engaging protrusion 222b. In this design, by providing the engaging protrusion 222b and the engaging recess 312b, when the rolling member 32 rolls to the locking point recess 141, the rolling member 32 is positioned in the locking point recess 141, thereby achieving fixation of the relative position between the swing member 31 and the base 10. The engagement between the engaging recess 312b and the engaging protrusion 222b brings the swing member 31 and the bracket 22 into a relatively static engaging state. Therefore, the rolling member 32 enables fixation of the relative position between the swing member 31 and the base 10 and fixation of the relative position between the bracket 22 and the base 10, thereby achieving fixation of the relative position between the rotary shaft 21 and the base 10.

As illustrated in FIG. 8, in a third example, the ring-shaped guide groove 14 is provided on the first bearing surface 11 of the base 10. The mating part 222 is the engaging recess 222a that is formed on the outer surface of the body of the bracket 22 and whose opening faces away from the axis of the rotary shaft 21. The engaging part 312 includes the engaging protrusion 312a, which is fixedly connected to the surface of the swing body 311 facing the axis of the rotary shaft 21. The rolling groove 13 is provided on the surface of the swing body 311 facing the first bearing surface 11 and extends to a surface of the engaging protrusion 312a facing the first bearing surface 11. When the rolling member 32 rolls to the locking point recess 141, the engaging protrusion 312a engages with the engaging recess 222a. In this design, by providing the engaging protrusion 312a and the engaging recess 222, when the rolling member 32 rolls to the locking point recess 141, the rolling member 32 is positioned in the locking point recess 141, thereby achieving fixation of the relative position between the swing member 31 and the base 10. The engagement between the engaging protrusion 312a and the engaging recess 222a brings the swing member 31 and the bracket 22 into a relatively static engaging state. Therefore, the rolling member 32 enables fixation of the relative position between the swing member 31 and the base 10 and fixation of the relative position between the bracket 22 and the base 10, thereby achieving fixation of the relative position between the rotary shaft 21 and the base 10.

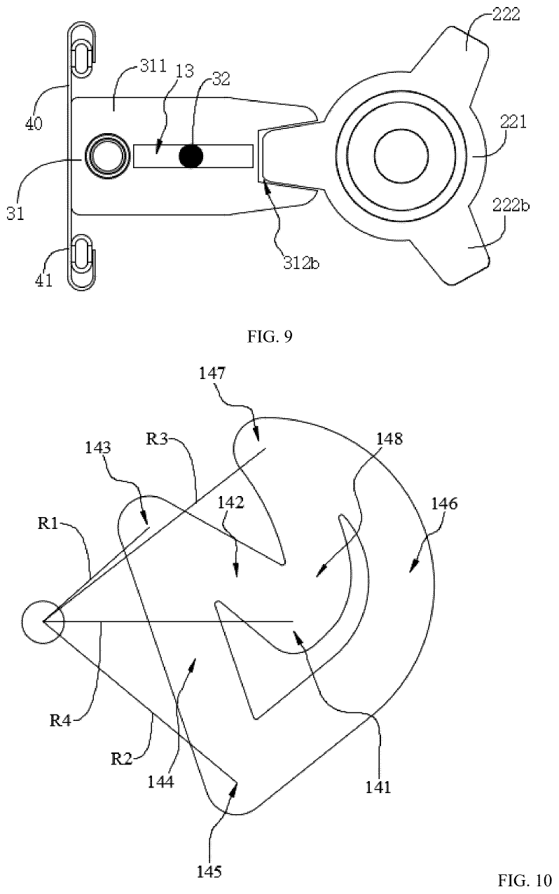

As illustrated in FIG. 9, in a fourth example, the ring-shaped guide groove 14 is provided on the first bearing surface 11 of the base 10, and the entire rolling groove 13 is provided on the surface of the swing body 311 facing the first bearing surface 11. The mating part 222 includes the engaging protrusion 222b, which is fixedly connected to the surface of the bracket body 221 facing the first bearing surface 11. The engaging part 312 is an engaging recess 312b that is formed on the surface of the swing body 311 facing the axis of the rotary shaft 21 and whose opening faces the axis of the rotary shaft 21. When the rolling member 32 rolls to the locking point recess 141, the engaging recess 312b engages with the engaging protrusion 222b. In this design, by providing the engaging protrusion 222b and the engaging recess 312b, when the rolling member 32 rolls to the locking point recess 141, the rolling member 32 is positioned in the locking point recess 141, thereby achieving fixation of the relative position between the swing member 31 and the base 10. The engagement between the engaging recess 312b and the engaging protrusion 222b brings the swing member 31 and the bracket 22 into a relatively static engaging state. Therefore, the rolling member 32 enables fixation of the relative position between the swing member 31 and the base 10 and fixation of the relative position between the bracket 22 and the base 10, thereby achieving fixation of the relative position between the rotary shaft 21 and the base 10.

It is worth mentioning that by providing the rolling groove 13 on the surface of the swing body 311 facing the first bearing surface 11, the size of the swing member 31 can be effectively reduced, thereby reducing the overall size of the wire body winding mechanism. As compared with a case of providing the entire rolling groove 13 on the surface of the swing body 311 facing the first bearing surface 11 the rolling groove 13 extends to the surface of the engaging protrusion 312a facing the first bearing surface 11, which can further reduce the size of the swing member 31, thereby further reducing the overall size of the wire body winding mechanism.

It is understandable that when the mating part 222 is the engaging recess 222a that is formed on the outer surface of the body of the bracket 22 and whose opening faces away from the axis of the rotary shaft 21, the number of engaging recesses 222a may be one or more (two or more). When one engaging recess 222a is provided, the bracket body 221 can achieve one-time engagement between the engaging protrusion 312a and the engaging recess 222a within a 360-degree rotation range. When multiple engaging recesses 222a are provided, the bracket body 221 can achieve multiple times of engagement between the engaging protrusion 312a and the engaging recess 222a within a 360-degree rotation range. When multiple engaging recesses 222a are provided, distribution of the multiple engaging recesses 222a on the bracket body 221 can be, but is not limited to, the following examples.

In a first example, two engaging recesses 222a are provided and are symmetrically distributed with respect to the axis of the rotary shaft 21. At this time, the bracket 22 can achieve the engagement between the engaging protrusion 312a and the engaging recess 222a every 180 degrees of rotation.

In a second example, three engaging recesses 222a are provided and are distributed at equal intervals around the axis of the rotary shaft 21. At this time, the bracket 22 can achieve the engagement between the engaging protrusion 312a and the engaging recess 222a every 120 degrees of rotation. This design can effectively enhance flexibility of extension or retraction of the wire body 92, allowing users to extend or retract the wire body 92 to a suitable length according to actual needs.

In a third example, three engaging recesses 222a are provided and are not distributed at equal intervals around the axis of the rotary shaft 21.

It should be noted that the more engaging recesses 222a are not necessarily better. Too many engaging recesses 222a may increase the size of the bracket body 221 to a certain extent, thus making the overall size of the wire body winding mechanism too large.

Considering that the reset member 40 is a structural component in the wire body winding mechanism that is configured to achieve the automatic reset of the swing member 31, principles of the automatic reset of the swing member 31 under the action of the reset member 40 can include the following.

In a first principle, the reset member 40 is adapted to (e.g., is configured to) generate elastic deformation. When the bracket 22 disengages from the swing member 31, the swing member 31 presses the reset member 40, so that the reset member 40 generates elastic deformation around a rotation axis of the swing member 31. The swing member 31 can rotate to engage with the bracket 22 under the action of an elastic restoring force of the reset member 40 around the rotation axis of the swing member 31.

As illustrated in FIGS. 6 to 9, regarding the automatic reset of the swing member 31 under the elastic restoring force of the reset member 40, specific forms of the reset member 40 can include the following examples.

In a first example, the reset member 40 includes an elastic piece 41. The elastic piece 41 is located on the side of the base 10 where the first bearing surface 11 is present, and is fixedly connected to the base 10. When the bracket 22 engages with the swing member 31, a surface of the swing member 31 facing away from the axis of the rotary shaft 21 abuts the elastic piece 41. When the bracket 22 disengages from the swing member 31, the swing member 31 swings and presses the elastic piece 41, causing the elastic piece 41 to generate elastic deformation in the direction of the rotation axis of the swing member 31, whereby the swing member 31 can rotate to engage with the bracket 22 under the action of an elastic restoring force of the elastic piece 41.

In a second example, the reset member 40 is a torsion spring, which is disposed around the rotation axis of the swing member 31. One end of the torsion spring is fixedly connected to the base 10, and the other end of the torsion spring is fixedly connected to the swing member 31. When the bracket 22 disengages from the swing member 31, the swing member 31 swings and presses the torsion spring, causing the torsion spring to generate elastic deformation in the direction of the rotation axis of the swing member 31, whereby the swing member 31 can rotate to engage with the bracket 22 under the action of an elastic restoring force of the torsion spring.

In a second principle, the reset member 40 is adapted to generate a magnetic attraction force. When the bracket 22 disengages from the swing member 31, the swing member 31 can rotate to engage with the bracket 22 under the action of the magnetic attraction force of the reset member 40.

For example, in one example, the reset member 40 includes two magnets, one of which is fixedly connected to the swing member 31 and the other is fixedly connected to the base 10. Magnetic poles of the two magnets that are close to each other have opposite magnetism. When the bracket 22 engages with the swing member 31, the two magnets are aligned in a direction perpendicular to the first bearing surface 11. When the bracket 22 disengages from the swing member 31, the two magnets are not aligned in the direction perpendicular to the first bearing surface 11. The swing member 31 can rotate to engage with the bracket 22 under the action of the magnetic attraction between the two magnets.

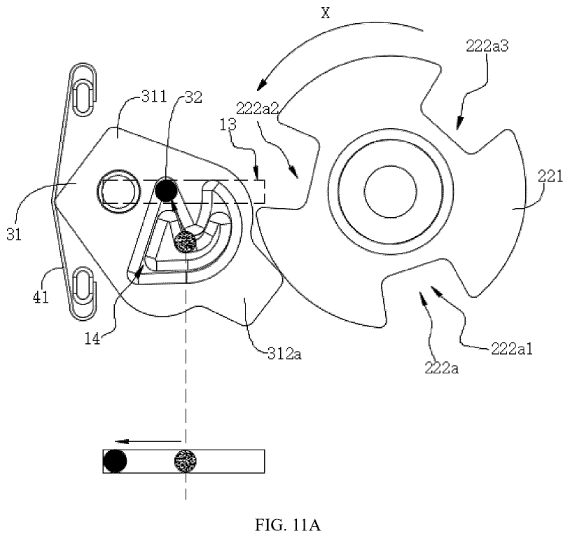

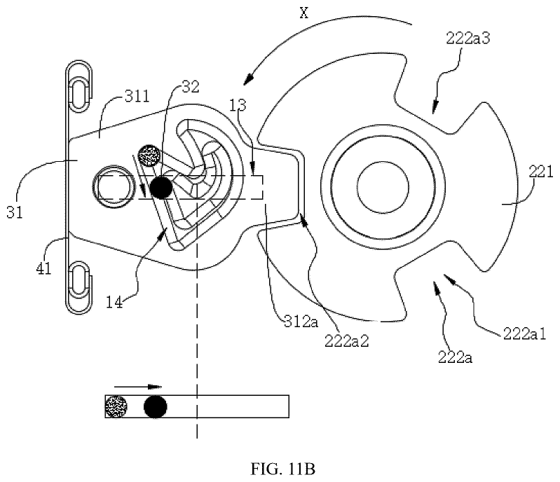

As illustrated in FIG. 10, the ring-shaped guide groove 14 serves as a movement track for the rolling member 32. The ring-shaped guide groove 14 further includes a first inflection point recess 143, a second inflection point recess 145, a third inflection point recess 147, a first recess segment 142, a second recess segment 144, a third recess segment 146, and a fourth recess segment 148. The first recess segment 142 is straight, with a first end communicating with the locking point recess 141 and a second end communicating with the first inflection point recess 143. The second recess segment 144 is also straight, with a first end communicating with the first inflection point recess 143 and a second end communicating with the second inflection point recess 145. The third recess segment 146 is curved and bends toward the rotation axis of the swing member 31, with a first end communicating with the second inflection point recess 145 and a second end communicating with the third inflection point recess 147. The fourth recess segment 148 is curved and bends toward the rotation axis of the swing member 31, with a first end communicating with the third inflection point recess 147 and a second end communicating with the locking point recess 141.

It should be noted that the first inflection point recess 143 is a circular recess, and a vertical distance (e.g., straight-line distance) between a center point of the first inflection point recess 143 and the rotation axis of the swing member 31 is a first distance R1. The second inflection point recess 145 is a circular recess, and a vertical distance between a center point of the second inflection point recess 145 and the rotation axis of the swing member 31 is a second distance R2. The third inflection point recess 147 is a circular recess, and a vertical distance between a center point of the third inflection point recess 147 and the rotation axis of the swing member 31 is a third distance R3. The locking point recess 141 is a circular recess, and a vertical distance between a center point of the locking point recess 141 and the rotation axis of the swing member 31 is a fourth distance R4. The first distance R1, the second distance R2, the third distance R3, and the fourth distance R4 may satisfy the condition formula: R1<R2<R4<R3.

Referring to FIG. 6, and 11A to 14, for example, the ring-shaped guide groove 14 is provided on the surface of the swing member 31 facing the first bearing surface 11, the rolling groove 13 is provided on the first bearing surface 11, the mating part 222 is the engaging recess 222a (the number of the engaging recesses 222a is three, and the three engaging recesses 222a are a first engaging recess 222a1, a second engaging recess 222a2, and a third engaging recess 222a3) that is formed on the outer surface of the body of the bracket 22 and whose opening faces away from the axis of the rotary shaft 21, the engaging part 312 includes the engaging protrusion 312a that is fixedly connected to the surface of the swing body 311 facing the axis of the rotary shaft 21, the reset member 40 is the elastic piece 41, and an elastic member (to be described below) is a coil spring 23. The working principle of the wire body winding mechanism is described briefly below.

As illustrated in FIGS. 6 and 10, when the wire body 92 is in an initial state, the engaging protrusion 312a engages with the first engaging recess 222a1, and the rolling member 32 is located in the locking point recess 141. At this time, the swing member 31 and the bracket 22 are both fixed relative to the base 10.

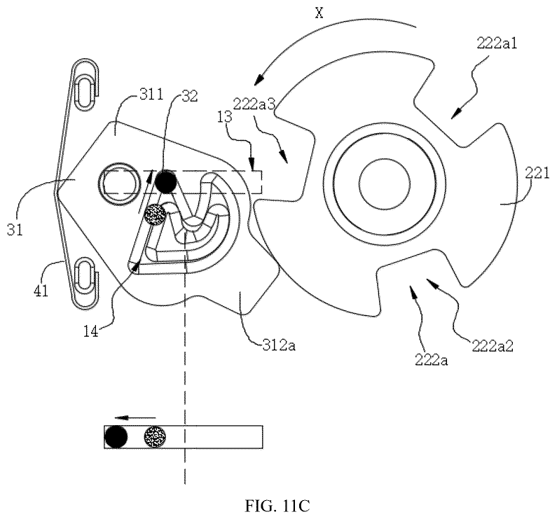

As illustrated in FIGS. 10 and 11A, the wire body 92 is pulled out from its initial state under the action of an external force, the engaging protrusion 312a disengages from the first engaging recess 222a1, and before the engaging protrusion 312a engages with the second engaging recess 222a2, the rolling member 32 rolls along the first recess segment 142 from the locking point recess 141 to the first inflection point recess 143.

As illustrated in FIGS. 10 and 11B, the wire body 92 continues to be pulled out under the action of the external force, the swing member 31 rotates under the action of the elastic restoring force of the elastic piece 41 until the moment when the engaging protrusion 312a engages with the second engaging recess 222a2, at which time the rolling member 32 leaves the first inflection point recess 143 and rolls along the second recess segment 144 to a certain intermediate transition position (as indicated by the “black” rolling member 32 in FIG. 11B).

As illustrated in FIGS. 10 and 11C, the wire body 92 continues to be pulled out under the action of the external force, the engaging protrusion 312a disengages from the second engaging recess 222a2, and before the engaging protrusion 312a engages with the third engaging recess 222a3 the rolling member 32 rolls from the certain intermediate transition position along the second recess segment 144 to the first inflection point recess 143 again.

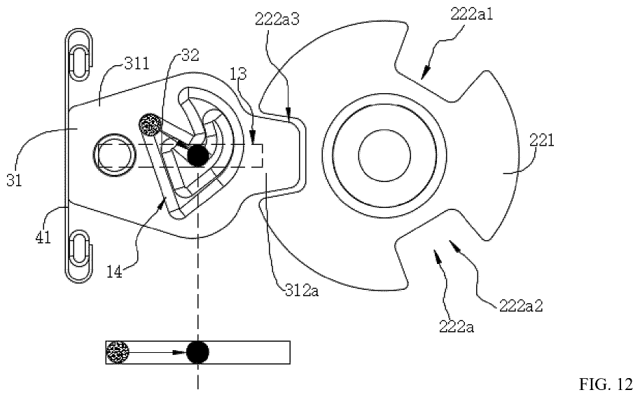

As illustrated in FIGS. 10 and 12, the wire body 92 continues to be pulled out under the action of the external force, the swing member 31 rotates under the action of the elastic restoring force of the elastic piece 41 until the moment when the engaging protrusion 312a engages with the third engaging recess 222a3, at which time the rolling member 32l leaves the first inflection point recess 143 and rolls along the first recess segment 142 to the certain intermediate transition position again.

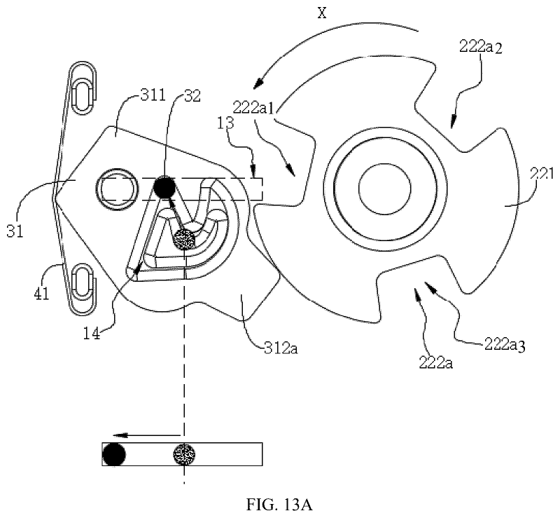

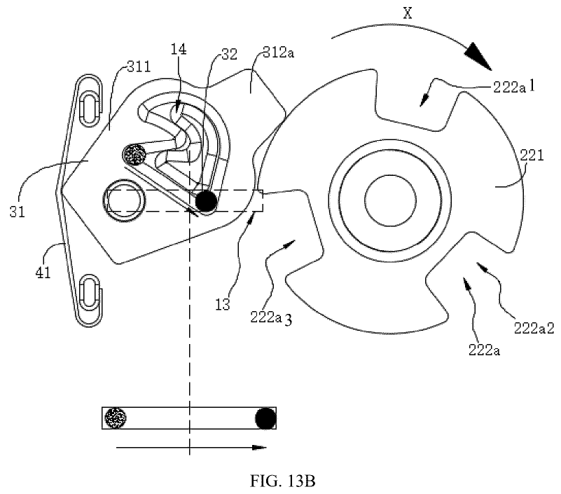

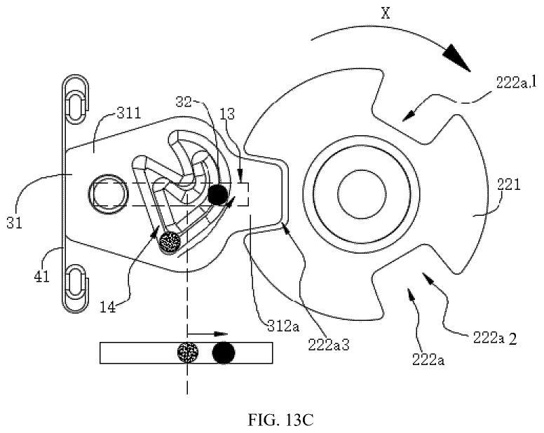

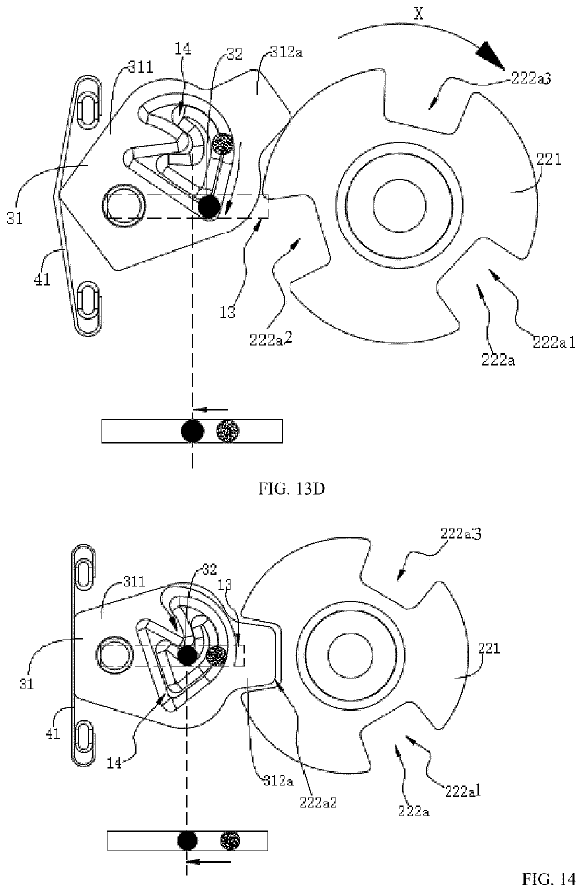

As illustrated in FIGS. 10 and 13A, the wire body 92 continues to be pulled out under the action of the external force, the engaging protrusion 312a disengages from the third engaging recess 222a3, and before the engaging protrusion 312a engages with the first engaging recess 222a1, the rolling member 32 rolls from the certain intermediate transition position along the first recess segment 142 to the first inflection point recess 143 again.

As illustrated in FIGS. 10 and 6, the wire body 92 continues to be pulled out under the action of the external force, the swing member 31 rotates under the action of the elastic restoring force of the elastic piece 41 until the moment when the engaging protrusion 312a engages with the first engaging recess 222a1 again, at which time the rolling member 32 leaves the first inflection point recess 143 and roll along the first recess segment 142 to the intermediate transition position again.

It should be noted that the above describes a rolling trajectory of the rolling member 32 in the ring-shaped guide groove 14 during the process in which the wire body 92 is pulled out from its initial state under the action of the external force and the bracket 22 rotates one turn (360 degrees) relative to the base 10. It is understandable that, if the wire body 92 continues to be pulled out under the action of the external force, the rolling member 32 repeats the above rolling trajectory in the ring-shaped guide groove 14.

During the process in which the wire body 92 is pulled out under the action of the external force, the external force acting on the wire body 92 may be removed at the moment when the engaging protrusion 312a engages with any of the engaging recesses 222a, or the external force acting on the wire body 92 may be removed during the process in which the engaging protrusion 312a disengages from any of the engaging recesses 222a.

As illustrated in FIG. 12, at the moment when the engaging protrusion 312a engages with any engaging recess 222a, the external force acting on the line body 92 is removed. At this time, the rolling member 32 is positioned in the locking point recess 141, so that the swing member 31 and the bracket 22 are fixed relative to the base 10, thereby achieving the positioning of the pulled-out wire body 92.

As illustrated in FIG. 12, the external force acting on the wire body 92 is removed during the process in which the engaging protrusion 312a disengages from any engaging recess 222a. At this time, under the action of the elastic restoring force of the elastic piece 41, the swing member 31 causes the rolling member 32 to roll from the first inflection point recess 143 along the second recess segment 144 to the second inflection point recess 145, then from the second inflection point recess 145 along the third recess segment 146 to the third inflection point recess 147, then from the third inflection point recess 147 along the fourth recess segment 148 to the locking point recess 141, and finally to be positioned in the locking point recess 141, so that the swing member 31 and the bracket 22 are both fixed relative to the base 10, thereby achieving the positioning after the wire body 92 is pulled out.

It is understandable that, in order that the pulled-out wire body 92 automatically winds and returns to its initial state under the action of the coil spring 23, first the wire body 92 is stretched to cause the rolling member 32 to leave the locking point recess 141, so that the swing member 31 and the bracket 22 both rotate relative to the base 10; then, after the wire body 92 is stretched to any length again, the external force acting on the wire body 92 can be removed, and the bracket 22 rotates in an opposite direction under a torsion of the coil spring 23. (Assuming that when the external force acting on the wire body 92 is removed, the engaging protrusion 312a just engages with the first engaging recess 222a1) As illustrated in FIGS. 10 and 13A, the wire body 92 is pulled out again from the positioned state after being pulled out, and the rolling member 32 rolls from the locking point recess 141 along the first recess segment 142 to the first inflection point recess 143.

As illustrated in FIGS. 10 and 13B, the bracket 22 rotates in the opposite direction under the torsion of the coil spring 23, the engaging protrusion 312a disengages from the first engaging recess 222a1, and before the engaging protrusion 312a engages with the third engaging recess 222a3, the rolling member 32 rolls from the first inflection point recess 143 along the second recess segment 144 to the second inflection point recess 145.

As illustrated in FIGS. 10 and 13C, the bracket 22 continues to rotate in the opposite direction under the torsion of the coil spring 23, the swing member 31 rotates until the moment when the engaging protrusion 312a engages with the third engaging recess 222a3 under the action of the elastic restoring force of the elastic piece 41, at which time the rolling member 32 moves from the second inflection point recess 145 along the third recess segment 146 to a second transition position. The second transition position is a position where the rolling groove 13 and the third recess segment 146 overlap when the engaging protrusion 312a engages with the third engaging recess 222a3.

As illustrated in FIGS. 10 and 13D, the bracket 22 continues to rotate in the opposite direction under the action of the coil spring 23, the engaging protrusion 312a disengages from the third engaging recess 222a3, and before the engaging protrusion 312a engages with the second engaging recess 222a2, the rolling member 32 rolls again from the second transition position along the third recess segment 146 to the second inflection point recess 145.

As illustrated in FIGS. 10 and 13C, the bracket 22 continues to rotate in the opposite direction under the action of the coil spring 23, the swing member 31 rotates under the action of the elastic restoring force of the elastic piece 41 until the moment when the engaging protrusion 312a engages with the second engaging recess 222a2, at which time the rolling member 32 leaves the second inflection point recess 145 and rolls back to the second transition position along the third recess segment 146.

As illustrated in FIGS. 10 and 13D, the bracket 22 continues to rotate in the opposite direction under the action of the coil spring 23, the engaging protrusion 312a disengages from the second engaging recess 222a2, and before the engaging protrusion 312a engages with the first engaging recess 222a1, the rolling member 32 rolls again from the second transition position along the third recess segment 146 to the second inflection point recess 145.

As illustrated in FIGS. 10 and 13C, the bracket 22 continues to rotate in the opposite direction under the action of the coil spring 23, the swing member 31 rotates under the action of the elastic restoring force of the elastic piece 41 until the moment at which the swing member 31 engages with the first engaging recess 222a1 again, at which time the rolling member 32 leaves the second inflection point recess 145 again and rolls back to the second transition position along the third recess segment 146.

It should be noted that the above describes a rolling trajectory of the rolling member 32 in the ring-shaped guide groove 14 during the process in which the stretched wire body 92 automatically winds from the positioned state under the torsion of the coil spring 23 and causes the bracket 22 to rotate one turn (360 degrees) in the opposite direction relative to the base 10. It is understandable that, if the wire body 92 continues to wind under the action of the coil spring 23, the rolling member 32 repeats the above rolling trajectory in the ring-shaped guide groove 14.

As illustrated in FIG. 14, when the bracket 22 rotates in the opposite direction under the torsion of the coil spring 23 until the moment when the wire body 92 completes automatic winding and returns to the initial state, the rolling member 32 rolls from the second inflection point recess 145 along the third recess segment 146 to the third inflection point recess 147, and then rolls from the third inflection point recess 147 along the fourth recess segment 148 to the locking point recess 141, and is finally positioned in the locking point recess 141, so that the swing member 31 and the bracket 22 are both fixed relative to the base 10, thereby achieving the positioning of the wire body 92 after winding.

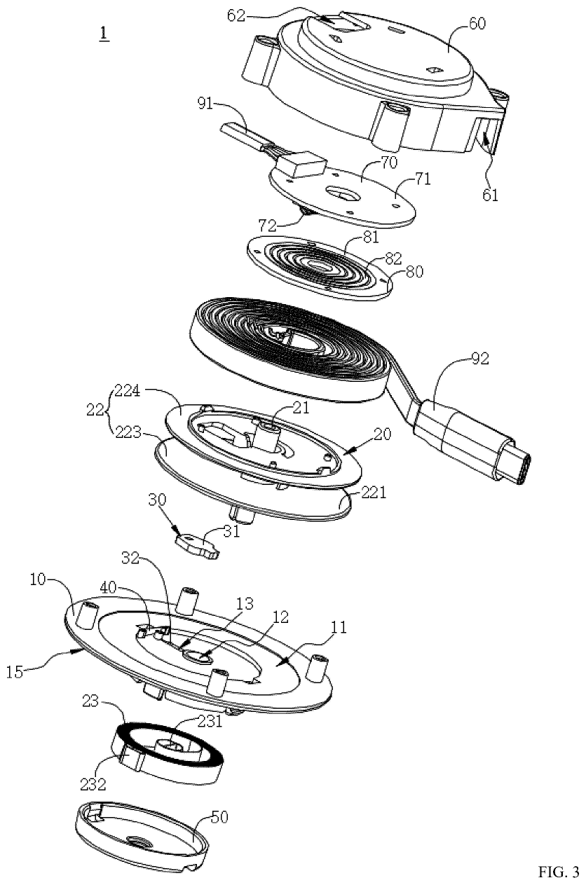

As illustrated in FIG. 3, considering that the winding assembly 20 can be configured to automatically wind the wire body 92, in some examples, the base 10 is designed to have a second bearing surface 15 opposite to the first bearing surface 11, and the mounting hole 12 communicates with the second bearing surface 15. The wire body winding mechanism further includes a first cover 50, at least part of which is located on the side of the base 10 where the second bearing surface 15 is, and the first cover 50 is connected to the base 10 to enclose and form a first accommodating cavity. The winding assembly 20 further includes an elastic member which is located in the first accommodating cavity and wound around the axis of the rotary shaft 21. A moving end 231 of the elastic member is fixedly connected to the rotary shaft 21, and a stationary end 232 of the elastic member is fixedly connected to the base 10. The first cover 50 may be fixedly connected to the base 10 by screwing or by snap fitting. The specific connection form between the first cover 50 and the base 10 is not limited here, and the designer can make reasonable designs according to the actual needs. The elastic member may be the coil spring 23 or a rubber band. In this design, the elastic member is provided to achieve the automatic winding of the wire body 92, which is simple in structure and convenient in operation. By providing the elastic member and the bracket 22 on two sides of the base 10 respectively, on one hand, a possibility that the wire body 92 gets entangled with the elastic member during the winding process can be effectively avoided; and on the other hand, the space on both sides of the base 10 can be fully utilized to effectively reduce the size of the base 10 and the bracket 22, thereby reducing the overall size of the wire body winding mechanism.

Referring to FIGS. 1 to 16, a second aspect of the present disclosure proposes a data cable device 1 including the wire body 92 and the above wire body winding mechanism. The wire body 92 is a data cable, and the data cable is wound around the rotary shaft 21 about the axis of the rotary shaft 21. In this design, the data cable device 1 including the above wire body winding mechanism can effectively prevent the rolling member 32 from directly contacting the bracket 22 during the process of extension or retraction of the data cable, thereby effectively reduce the possibility of wear on the bracket 22 when the rolling member 32 rolls in the rolling groove 13 and the ring-shaped guide groove 14.

Further, as illustrated in FIGS. 3 and 5, in some examples, the bracket 22 includes a first frame 223 and a second frame 224. The first frame 223 is fixedly connected to the rotary shaft 21, and the second frame 224 is fixedly connected to the rotary shaft 21. The second frame 224 and the first frame 223 are spaced apart along the axis of the rotary shaft 21. The second frame 224 is further away from the first bearing surface 11 than the first frame 223. The data cable is sandwiched between the first frame 223 and the second frame 224. In this design, the data cable is sandwiched between the first frame 223 and the second frame 224. During the process of extension or retraction of the data cable, the first frame 223 and the second frame 224 limit the data cable, which can effectively ensure regularity of the data cable winding around the rotary shaft 21, thereby effectively reducing the possibility that the data cable is entangled during the process of extension or retraction of the data cable.

Further, as illustrated in FIG. 3, in some examples, the data cable device 1 further includes a second cover 60, an input circuit board 70, an output circuit board 80, and an inserter 91. The second cover 60 is at least partially located on the side of the base 10 where the first bearing surface 11 is, and the second cover 60 is connected to the base 10 to enclose and form a second accommodating cavity. The second cover 60 has a cable outlet hole 61 for the data cable to pass through the second accommodating cavity, and the second cover 60 further has a through hole 62. The input circuit board 70 is located in the second accommodating cavity and is fixedly connected to the second cover 60. The output circuit board 80 is located on a side of the second frame 224 facing away from the first bearing surface 11, and the output circuit board 80 is electrically connected to the data cable and the input circuit board 70. The inserter 91 is configured to be electrically connected to an external component, the inserter 91 passes through the through hole 62 and is fixedly connected to the input circuit board 70, and the inserter 91 is further electrically connected to the input circuit board 70.

The second cover 60 may be fixedly connected to the base 10 by screwing or snap fitting. The specific connection form between the second cover 60 and the base 10 is not limited here, and the designer can make reasonable designs according to actual needs. The input circuit board 70 may be fixedly connected to the second cover 60 by screwing, snap fitting, or gluing. The specific connection form between the input circuit board 70 and the second cover 60 is not limited here, and the designer can make reasonable designs according to actual needs. The output circuit board 80 may be fixedly connected to the second frame 224 by screwing, snap-fitting, or gluing. The specific connection form between the output circuit board 80 and the second frame 224 is not limited here, and the designer can make reasonable designs according to actual needs. The inserter 91 may be a plug alone, in which case the external component may be an external power source. The inserter 91 may also be an interface alone, the type of which may be, but is not limited to, a USB interface or a Type-C interface, in which case the external component may be an external plug or an external interface. The inserter 91 may also be a combination of a plug and an interface, in which case the external component may be an external power source, an external plug, or an external interface.

In this design, the design of the second cover 60 can provide good protection for the first frame 223, the second frame 224, the data cable, and the like. The design of the inserter 91, the input circuit board 70 and the output circuit board 80 can achieve the electrical connection between the data cable and the external components, thereby effectively ensuring the communication or power transmission of the data cable.

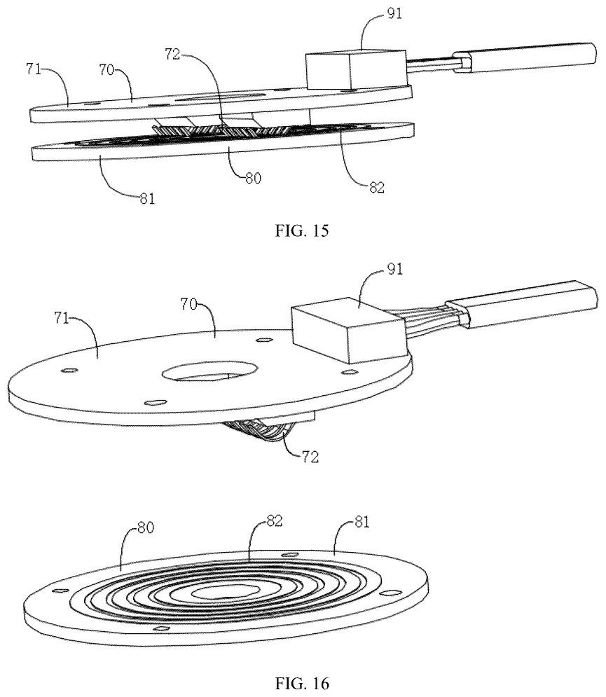

Further, as illustrated in FIGS. 15 and 16, in some examples, the input circuit board 70 includes a first circuit board 71 and an electrical contact 72. The first circuit board 71 is fixedly connected to the second cover 60, and the electrical contact 72 is disposed on a side of the first circuit board 71 facing the first bearing surface 11 and is electrically connected to the first circuit board 71. The output circuit board 80 includes a second circuit board 81 and a ring-shaped electrical connection piece 82 disposed around the axis of the rotary shaft 21, and the second circuit board 81 is fixedly connected to the second frame 224. The ring-shaped electrical connection piece 82 is disposed on a side of the second circuit board 81 facing away from the first bearing surface 11, is electrically connected to the second circuit board 81, and contacts the electrical contact 72.

In this design, by designing the electrical contact 72 to contact the ring-shaped electrical connection piece 82, when the data cable extends or contracts, the electrical connection between the second circuit board 81 and the first circuit board 71 can be ensured during the process in which the second circuit board 81 follows the second frame 224 to rotate, thereby effectively ensuring the communication or power transmission of the data cable.

In some other examples, the input circuit board 70 may include the first circuit board 71 and the ring-shaped electrical connection piece 82. The first circuit board 71 may be fixedly connected to the second cover 60, and the ring-shaped electrical connection piece 82 may be provided on a side of the first circuit board 71 facing the first bearing surface 11 and electrically connected to the first circuit board 71. In this case, the output circuit board 80 includes the second circuit board 81 and the electrical contact 72, and the second circuit board 81 is fixedly connected to the second frame 224, the electrical contact 72 is disposed on a side of the second circuit board 81 facing away from the first bearing surface 11, is electrically connected to the second circuit board 81, and contact the ring-shaped electrical connection piece 82.

The same or similar reference signs in the drawings correspond to the same or similar components. In description of the present disclosure, it should be understood that the terms “upper”, “lower”, “left”, “right”, and the like indicating orientation or position relationships are based on orientation or position relationships shown in the drawings, and are intended to describe the disclosure and simplify description only but not to indicate or imply that the referred device or element must have a particular orientation and be configured and operated in a particular orientation. Therefore, the terms used to describe position relationships are intended to be illustrative only but not to limit the present disclosure. For those skilled in the art, specific meanings of the above terms can be understood according to specific situations.

The above are only some examples of the present disclosure and are not intended to limit the disclosure. Any modifications, equivalent substitutions, improvements or the like within the spirit and principle of the disclosure should be included in the scope of the disclosure.

What is claimed is:

1. A wire winding system comprising:
a base having a bearing surface, wherein the bearing surface comprises a mounting hole and one of a ring-shaped guide groove and a rolling groove, and the ring-shaped guide groove comprises a locking point recess;
a winding assembly configured to automatically wind a wire and comprising a rotary shaft and a bracket, wherein the rotary shaft passes through the mounting hole and is rotatably connected to the base, the bracket is located on a side of the base where the bearing surface is, and is fixedly connected to the rotary shaft, and the wire rests against a side of the bracket;
a locking assembly located between the bearing surface and the bracket, wherein the locking assembly comprises a swing member and a rolling member, the swing member is rotatably connected to the base, a surface of the swing member comprises the other of the ring-shaped guide groove and the rolling groove, and the rolling member is embedded in the rolling groove and the ring-shaped guide groove; and
a reset member connected to the base,
wherein extension or retraction of the wire drives the rotary shaft and the bracket to rotate synchronously, such that the bracket selectively engages with or disengages from the swing member to drive the swing member to swing, and wherein the swing member is configured to drive the rolling member to roll along the rolling groove and the ring-shaped guide groove.

2. The wire winding system of claim 1, wherein in response to the rolling member rolling to the locking point recess, the bracket is engaged with the swing member such that a position of the rotary shaft is fixed relative to the base, and in response to the bracket being disengaged from the swing member, the reset member is configured to cause the swing member to rotate to engage with the bracket.

3. The wire winding system of claim 2, wherein:
the bracket comprises a bracket body and a mating part,
the bracket body is fixedly connected to the rotary shaft,
the swing member comprises a swing portion and an engaging portion, and the swing portion is rotatably connected to the base,
the ring-shaped guide groove is provided on a surface of the swing portion, or at least part of the rolling groove is provided on the surface of the swing portion, and
in response to the rolling member rolling to the locking point recess, the mating part engages with the engaging portion.

4. The wire winding system of claim 3, wherein:
the ring-shaped guide groove is provided on the swing portion,
the mating part comprises a recess that is formed in an outer surface of the bracket body,
the engaging portion comprises a protrusion fixedly connected to the swing portion, and
in response to the rolling member rolling to the locking point recess, the protrusion engages with the recess.

5. The wire winding system of claim 4, wherein the mating part comprises at least two recesses, and the at least two recesses are distributed at equal intervals around an axis of the rotary shaft.

6. The wire winding system of claim 3, wherein:
the rolling groove is provided on the swing portion,
the mating part comprises a recess that is formed in an outer surface of the bracket body,
the engaging portion comprises a protrusion fixedly connected to the swing portion, and
in response to the rolling member rolling to the locking point recess, the protrusion engages with the recess.

7. The wire winding system of claim 1, wherein:
in response to the bracket disengaging from the swing member, the swing member presses the reset member such as that the reset member generates elastic deformation around a rotation axis of the swing member, and
the swing member is configured to rotate to engage with the bracket under action of an elastic restoring force of the reset member.

8. The wire winding system of claim 1, wherein the reset member comprises one of an elastic piece or a torsion spring.

9. The wire winding system of claim 1, wherein the ring-shaped guide groove comprises:
a first inflection point recess, a second inflection point recess, and a third inflection point recess;
a first straight recess segment with a first end communicating with the locking point recess and a second end communicating the first inflection point recess;
a second straight recess segment with a first end communicating with the first inflection point recess and a second end communicating with the second inflection point recess;
a third curved recess segment with a first end communicating with the second inflection point recess and a second end communicating with the third inflection point recess; and
a fourth curved recess segment with a first end communicating with the third inflection point recess and a second end communicating with the locking point recess.

10. The wire winding system of claim 1, wherein:
the base further comprises a second bearing surface opposite to the bearing surface, and the mounting hole communicates with the second bearing surface,
the wire winding system further comprises a cover connected to the base to form an accommodating cavity, and at least part of the cover is located on a side of the base where the second bearing surface is, and
the wire winding system further comprises an elastic member located in the accommodating cavity and wound around an axis of the rotary shaft, a moving end of the elastic member is fixedly connected to the rotary shaft, and a stationary end of the elastic member is fixedly connected to the base.

11. A data cable device comprising a data cable and a wire winding system, wherein the wire winding system comprises:
a base having a bearing surface, wherein the bearing surface comprises a mounting hole and one of a ring-shaped guide groove and a rolling groove, and the ring-shaped guide groove comprises a locking point recess;
a winding assembly configured to automatically wind a wire and comprising a rotary shaft and a bracket, wherein the rotary shaft passes through the mounting hole and is rotatably connected to the base, the bracket is located on a side of the base where the bearing surface is, and is fixedly connected to the rotary shaft, and the wire rests against a side of the bracket;
a locking assembly located between the bearing surface and the bracket, wherein the locking assembly comprises a swing member and a rolling member, the swing member is rotatably connected to the base, a surface of the swing member comprises the other of the ring-shaped guide groove and the rolling groove, and the rolling member is embedded in the rolling groove and the ring-shaped guide groove; and
a reset member connected to the base,
wherein extension or retraction of the wire drives the rotary shaft and the bracket to rotate synchronously, such that the bracket selectively engages with or disengages from the swing member to drive the swing member to swing, and the swing member is configured to drive the rolling member to roll along the rolling groove and the ring-shaped guide groove, and
wherein the data cable is wound around the rotary shaft about an axis of the rotary shaft.

12. The data cable device of claim 11, wherein the bracket comprises:
a first frame fixedly connected to the rotary shaft,
a second frame fixedly connected to the rotary shaft,
the second frame and the first frame are spaced apart along the axis of the rotary shaft, and
the data cable is sandwiched between the first frame and the second frame.

13. The data cable device of claim 12, further comprising:
a cover connected to the base to form an accommodating cavity, wherein at least part of the cover is located on a side of the base where the bearing surface is, and the cover comprises a cable outlet hole;
an input circuit board located in the accommodating cavity and fixedly connected to the cover;
an output circuit board fixedly connected to the second frame, and electrically connected to the data cable and the input circuit board; and
an inserter configured to be electrically connected to an external component, fixedly connected to the input circuit board, and electrically connected to the input circuit board.

14. The data cable device of claim 13, wherein the input circuit board comprises a first circuit board and an electrical contact, the first circuit board is fixedly connected to the cover, and the electrical contact is disposed on a side of the first circuit board and is electrically connected to the first circuit board; and
the output circuit board comprises a second circuit board and a ring-shaped electrical connection piece that is disposed around the axis of the rotary shaft, the second circuit board is fixedly connected to the second frame, and the ring-shaped electrical connection piece is disposed on a side of the second circuit board, electrically connected to the second circuit board, and contacts the electrical contact.

15. The data cable device of claim 11, wherein:
the bracket comprises a bracket body and a mating part, the bracket body is fixedly connected to the rotary shaft, and the mating part is provided on a side of the bracket body,
the swing member comprises a swing portion and an engaging portion, and the swing portion is rotatably connected to the base,
the ring-shaped guide groove is provided on a surface of the swing portion, or at least part of the rolling groove is provided on the surface of the swing portion facing the bearing surface, and
in response to the rolling member rolling to the locking point recess, the mating part engages with the engaging portion.

16. The data cable device of claim 15, wherein the ring-shaped guide groove is provided on the surface of the swing portion facing the bearing surface,
the mating part comprises an engaging recess that is formed in an outer surface of the bracket body, and an opening of the mating part faces away from an axis of the rotary shaft,
the engaging portion comprises a protrusion fixedly connected to a surface of the swing portion, and
in response to the rolling member rolling to the locking point recess, the protrusion engages with the engaging recess.

17. The data cable device of claim 16, wherein the mating part comprises at least two engaging recesses, and the at least two engaging recesses are distributed at equal intervals around the axis of the rotary shaft.

18. The data cable device of claim 16, wherein:
the rolling groove is provided on the surface of the swing portion facing the bearing surface and extends to a surface of the protrusion facing the bearing surface, and
in response to the rolling member rolling to the locking point recess, the protrusion engages with the engaging recess.

19. The data cable device of claim 11, wherein:
in response to the bracket disengaging from the swing member, the swing member presses the reset member such as that the reset member generates elastic deformation around a rotation axis of the swing member, and
the swing member is configured to rotate to engage with the bracket under action of an elastic restoring force of the reset member around the rotation axis of the swing member.

20. The wire winding system of claim 19, wherein the reset member comprises one of an elastic piece or a torsion spring.
